(19) United States
(12) Patent Application Publication
(10) Pub. No.: US 2011/0220077 A1
(43) Pub. Date: Sep. 15, 2011

(54) SPLIT-CYCLE AIR-HYBRID ENGINE WITH FIRING AND CHARGING MODE

(75) Inventors: Riccardo Meldolesi, Shoreham-by-Sea (GB); Nicholas Badain, Shoreham-by-Sea (GB); Ian Gilbert, Shoreham-by-Sea (GB)

(73) Assignee: SCUDERI GROUP, LLC, West Springfield, MA (US)

(21) Appl. No.: 13/046,816

(22) Filed: Mar. 14, 2011

Related U.S. Application Data
(60) Provisional application No. 61/313,831, filed on Mar. 15, 2010.
(60) Provisional application No. 61/363,825, filed on Jul. 13, 2010.
(60) Provisional application No. 61/365,343, filed on Jul. 18, 2010.

(51) Int. Cl. F02B 33/22

(52) U.S. Cl. 123/70 R

(57) ABSTRACT

A split-cycle air-hybrid engine includes a rotatable crankshaft. A compression piston is slidably received within a compression cylinder and operatively connected to the crankshaft. An intake valve selectively controls air flow into the compression cylinder. An expansion piston is slidably received within an expansion cylinder and operatively connected to the crankshaft. A crossover passage interconnects the compression and expansion cylinders. The crossover passage includes a crossover compression (XovrC) valve and crossover expansion (XovrE) valve therein. An air reservoir is operatively connected to the crossover passage. An air reservoir valve selectively controls air flow into and out of the air reservoir. In a Firing and Charging (FC) mode of the engine, the air reservoir valve is kept closed until the XovrE valve is substantially closed during a single rotation of the crankshaft such that the expansion cylinder is charged with compressed air before the air reservoir is charged with compressed air.

### CROSS-REFERENCE TO RELATED APPLICATIONS

This application claims the priority of U.S. Provisional Application No. 61/313,831 filed Mar. 15, 2010, U.S. Provisional Application No. 61/363,825 filed Jul. 13, 2010, and U.S. Provisional Application No. 61/365,343 filed Jul. 18, 2010.

### TECHNICAL FIELD

This invention relates to split-cycle engines and, more particularly, to such an engine incorporating an air-hybrid system.

### BACKGROUND OF THE INVENTION

For purposes of clarity, the term “conventional engine” as used in the present application refers to an internal combustion engine wherein all four strokes of the well-known Otto cycle (i.e., the intake (or inlet), compression, expansion (or power) and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

U.S. Pat. No. 6,543,225 granted Apr. 8, 2003 to Scuderi and U.S. Pat. No. 6,952,923 granted Oct. 11, 2005 to Branyon et al., both of which are incorporated herein by reference, contain an extensive discussion of split-cycle and similar-type engines. In addition, these patents disclose details of prior versions of an engine of which the present disclosure details further developments.

Split-cycle air-hybrid engines combine a split-cycle engine with an air reservoir and various controls. This combination enables a split-cycle air-hybrid engine to store energy in the form of compressed air in the air reservoir. The compressed air in the air reservoir is later used in the expansion cylinder to power the crankshaft.

A split-cycle air-hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

U.S. Pat. No. 7,353,786 granted Apr. 8, 2008 to Scuderi et al., which is incorporated herein by reference, contains an extensive discussion of split-cycle air-hybrid and similar-type engines. In addition, this patent discloses details of prior hybrid systems of which the present disclosure details further developments.

A split-cycle air-hybrid engine can be run in a normal operating or firing (NF) mode (also commonly called the Engine Firing (EF) mode) and four basic air-hybrid modes. In the EF mode, the engine functions as a non-air hybrid split-cycle engine, operating without the use of its air reservoir. In the EF mode, a tank valve operatively connecting the crossover passage to the air reservoir remains closed to isolate the air reservoir from the basic split-cycle engine.

The split-cycle air-hybrid engine operates with the use of its air reservoir in four hybrid modes. The four hybrid modes are:
1) Air Expander (AE) mode, which includes using compressed air energy from the air reservoir without combustion;
2) Air Compressor (AC) mode, which includes storing compressed air energy into the air reservoir without combustion;
3) Air Expander and Firing (AEF) mode, which includes using compressed air energy from the air reservoir with combustion; and
4) Firing and Charging (FC) mode, which includes storing compressed air energy into the air reservoir with combustion.
   However, further optimization of these modes, EF, AE, AC, AEF and FC, is desirable to enhance efficiency and reduce emissions.

### SUMMARY OF THE INVENTION

The present invention provides a split-cycle air-hybrid engine in which the use of the Firing and Charging (FC) mode is optimized for potentially any vehicle in any drive cycle for improved efficiency.

More particularly, an exemplary embodiment of a split-cycle air-hybrid engine in accordance with the present invention includes a crankshaft rotatable about a crankshaft axis. A compression piston is slidably received within a compression cylinder and operatively connected to the crankshaft such that the compression piston reciprocates through an intake stroke and a compression stroke during a single rotation of the crankshaft. An intake (or inlet) valve selectively controls air flow into the compression cylinder. An expansion piston is slidably received within an expansion cylinder and operatively connected to the crankshaft such that the expansion piston reciprocates through an expansion stroke and an exhaust stroke during a single rotation of the crankshaft. A crossover passage interconnects the compression and expansion cylinders. The crossover passage includes a crossover compression (XovrC) valve and a crossover expansion (XovrE) valve defining a pressure chamber therebetween. An air reservoir is operatively connected to the crossover passage and selectively operable to store compressed air from the compression cylinder. An air reservoir valve selectively controls air flow into and out of the air reservoir. The engine is operable in a Firing and Charging (FC) mode. In the FC mode, the air reservoir valve is kept closed until the XovrE valve is substantially closed during a single rotation of the crankshaft such that the expansion cylinder is charged with compressed air before the air reservoir is charged with compressed air.

A method of operating a split-cycle air-hybrid engine is also disclosed. The split-cycle air-hybrid engine includes a crankshaft rotatable about a crankshaft axis. A compression piston is slidably received within a compression cylinder and operatively connected to the crankshaft such that the compression piston reciprocates through an intake stroke and a compression stroke during a single rotation of the crankshaft. An intake valve selectively controls air flow into the compression cylinder. An expansion piston is slidably received within an expansion cylinder and operatively connected to the crankshaft such that the expansion piston reciprocates through an expansion stroke and an exhaust stroke during a single rotation of the crankshaft. A crossover passage interconnects the compression and expansion cylinders. The crossover passage includes a crossover compression (XovrC) valve and a crossover expansion (XovrE) valve defining a pressure chamber therebetween. An air reservoir is operatively connected to the crossover passage and selectively operable to store compressed air from the compression cylinder. An air reservoir valve selectively controls air flow into and out of the air reservoir. The engine is operable in a Firing and Charging (FC) mode. The method in accordance with the present invention includes the following steps: drawing in and compressing inlet (or intake) air with the compression piston; admitting compressed air from the compression cylinder into the expansion cylinder with fuel, at the beginning of an expansion stroke, the fuel being ignited, burned and expanded on the same expansion stroke of the expansion piston, transmitting power to the crankshaft, and the combustion products being discharged on the exhaust stroke; and keeping the air reservoir valve closed until the XovrE valve is substantially closed during a single rotation of the crankshaft such that the expansion cylinder is charged with compressed air before the air reservoir is charged with compressed air.

These and other features and advantages of the invention will be more fully understood from the following detailed description of the invention taken together with the accompanying drawings.

### BRIEF DESCRIPTION OF THE DRAWINGS

In the drawings:

FIG. 1 is a lateral sectional view of an exemplary split-cycle air-hybrid engine in accordance with the present invention;

FIG. 2 is a graphical illustration of intake (inlet) valve closing timing with respect to tank air pressure and tank air flowrate at an engine speed of 2000 revolutions per minute (rpm) and engine load of 2 bar Indicated Mean Effective Pressure (IMEP);

FIG. 3 is a graphical illustration of intake valve duration with respect to tank air pressure and tank air flowrate at an engine speed of 2000 rpm and engine load of 2 bar IMEP;

FIG. 4 is a graphical illustration of crossover compression (XovrC) valve duration with respect to tank air pressure and tank air flowrate at an engine speed of 2000 rpm and engine load of 2 bar IMEP;

FIG. 5 is a graphical illustration of crossover expansion (XovrE) valve duration with respect to tank air pressure and tank air flowrate at an engine speed of 2000 rpm and engine load of 2 bar IMEP;

FIG. 6 is a graphical illustration of XovrC valve opening timing with respect to tank air pressure and tank air flowrate at an engine speed of 2000 rpm and engine load of 2 bar IMEP;

FIG. 7 is a graphical illustration of XovrC valve closing timing with respect to tank air pressure and tank air flowrate at an engine speed of 2000 rpm and engine load of 2 bar IMEP;

FIG. 8 is a graphical illustration of XovrE valve opening timing with respect to tank air pressure and tank air flowrate at an engine speed of 2000 rpm and engine load of 2 bar IMEP;

FIG. 9 is a graphical illustration of XovrE valve closing timing with respect to tank air pressure and tank air flowrate at an engine speed of 2000 rpm and engine load of 2 bar IMEP;

FIG. 10 is a graphical illustration of air tank valve opening timing with respect to tank air pressure and tank air flowrate at an engine speed of 2000 rpm and engine load of 2 bar IMEP;

FIG. 11 is a graphical illustration of air tank valve closing timing with respect to tank air pressure and tank air flowrate at an engine speed of 2000 rpm and engine load of 2 bar IMEP; and

FIG. 12 is a graphical illustration of fuel flowrate with respect to tank air pressure for various tank air flowrates at an engine speed of 2000 rpm and engine load of 2 bar IMEP.

### DETAILED DESCRIPTION OF THE INVENTION

The following glossary of acronyms and definitions of terms used herein is provided for reference.

### In General

Unless otherwise specified, all valve opening and closing timings are measured in crank angle degrees after top dead center of the expansion piston (ATDCe).

Unless otherwise specified, all valve durations are in crank angle degrees (CA).

Air tank (or air storage tank): Storage tank for compressed air.
ATDCe: After top dead center of the expansion piston.
Bar: Unit of pressure, 1 bar=10⁵ N/m²
BMEP: Brake mean effective pressure. The term “Brake” refers to the output as delivered to the crankshaft (or output shaft), after friction losses (FMEP) are accounted for. Brake Mean Effective Pressure (BMEP) is the engine's brake torque output expressed in terms of a mean effective pressure (MEP) value. BMEP is equal to the brake torque divided by engine displacement. This is the performance parameter taken after the losses due to friction. Accordingly, BMEP=IMEP−friction. Friction, in this case is usually also expressed in terms of an MEP value known as Frictional Mean Effective Pressure (or FMEP).
Compressor: The compression cylinder and its associated compression piston of a split-cycle engine.
Expander: The expansion cylinder and its associated expansion piston of a split-cycle engine.

### FMEP: Frictional Mean Effective Pressure.

g/s: Grams per second.
IMEP: Indicated Mean Effective Pressure. The term “Indicated” refers to the output as delivered to the top of the piston, before friction losses (FMEP) are accounted for.
Inlet (or intake): Inlet valve. Also commonly referred to as an intake valve.
Inlet air (or intake air): Air drawn into the compression cylinder on an intake (or inlet) stroke.
Inlet valve (or intake valve): Valve controlling intake of gas into the compression cylinder.

### RPM: Revolutions Per Minute.

Tank valve: Valve connecting the Xovr passage with the compressed air storage tank.
Valve duration: The interval in crank degrees between start of valve opening and end of valve closing.
VVA: Variable valve actuation. A mechanism or method operable to alter the shape or timing of a valve's lift profile.
Xovr (or Xover) valve, passage or port: The crossover valves, passages, and/or ports which connect the compression and expansion cylinders through which gas flows from compression to expansion cylinder.
XovrC (or XoverC) valves: Valves at the compressor end of the Xovr passage.
XovrE (or XoverE) valves: Valves at the expander end of the crossover (Xovr) passage.

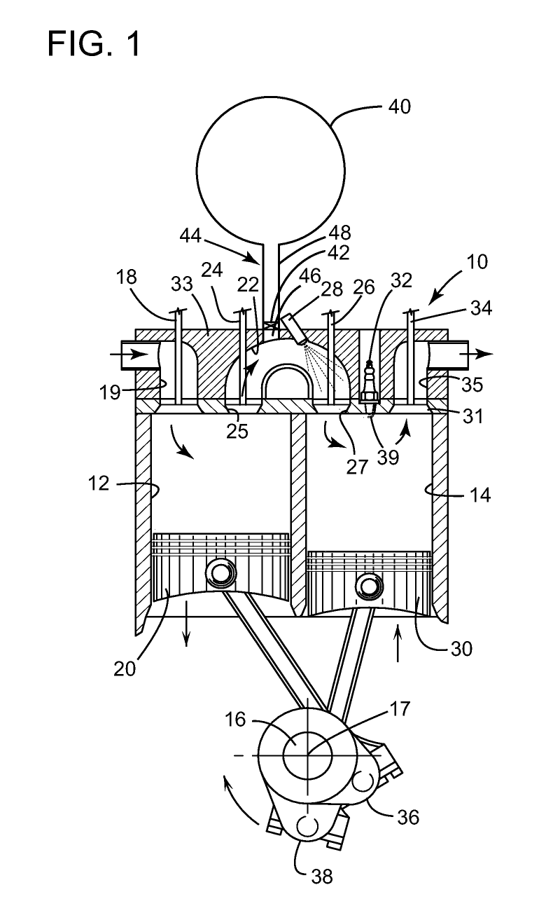

Referring to FIG. 1, an exemplary split-cycle air-hybrid engine is shown generally by numeral 10. The split-cycle air-hybrid engine 10 replaces two adjacent cylinders of a conventional engine with a combination of one compression cylinder 12 and one expansion cylinder 14. A cylinder head 33 is typically disposed over an open end of the expansion and compression cylinders 12, 14 to cover and seal the cylinders.

The four strokes of the Otto cycle are “split” over the two cylinders 12 and 14 such that the compression cylinder 12, together with its associated compression piston 20, perform the intake (or inlet) and compression strokes, and the expansion cylinder 14, together with its associated expansion piston 30, perform the expansion (or power) and exhaust strokes. The Otto cycle is therefore completed in these two cylinders 12, 14 once per crankshaft 16 revolution (360 degrees CA) about crankshaft axis 17.

During the intake stroke, intake (or inlet) air is drawn into the compression cylinder 12 through an intake port 19 disposed in the cylinder head 33. An inwardly opening (opening inwardly into the cylinder and toward the piston) poppet intake (or inlet) valve 18 controls fluid communication between the intake port 19 and the compression cylinder 12.

During the compression stroke, the compression piston 20 pressurizes the air charge and drives the air charge into the crossover passage (or port) 22, which is typically disposed in the cylinder head 33. This means that the compression cylinder 12 and compression piston 20 are a source of high-pressure gas to the crossover passage 22, which acts as the intake passage for the expansion cylinder 14. In some embodiments, two or more crossover passages 22 interconnect the compression cylinder 12 and the expansion cylinder 14.

The geometric (or volumetric) compression ratio of the compression cylinder 12 of split-cycle engine 10 (and for split-cycle engines in general) is herein commonly referred to as the “compression ratio” of the split-cycle engine. The geometric (or volumetric) compression ratio of the expansion cylinder 14 of split-cycle engine 10 (and for split-cycle engines in general) is herein commonly referred to as the “expansion ratio” of the split-cycle engine. The geometric compression ratio of a cylinder is well known in the art as the ratio of the enclosed (or trapped) volume in the cylinder (including all recesses) when a piston reciprocating therein is at its bottom dead center (BDC) position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high compression ratios (e.g., to 1, 30 to 1, 40 to 1, or greater) within the compression cylinder 12, an outwardly opening (opening outwardly away from the cylinder) poppet crossover compression (XovrC) valve 24 at the crossover passage inlet 25 is used to control flow from the compression cylinder 12 into the crossover passage 22. Due to very high expansion ratios (e.g., 20 to 1, 30 to 1, 40 to 1, or greater) within the expansion cylinder 14, an outwardly opening poppet crossover expansion (XovrE) valve 26 at the outlet 27 of the crossover passage 22 controls flow from the crossover passage 22 into the expansion cylinder 14. The actuation rates and phasing of the XovrC and XovrE valves 24, 26 are timed to maintain pressure in the crossover passage 22 at a high minimum pressure (typically 20 bar or higher at full load) during all four strokes of the Otto cycle.

At least one fuel injector 28 injects fuel into the pressurized air at the exit end of the crossover passage 22 in correspondence with the XovrE valve 26 opening, which occurs shortly before expansion piston 30 reaches its top dead center position. The air/fuel charge enters the expansion cylinder 14 when expansion piston 30 is close to its top dead center position. As piston 30 begins its descent from its top dead center position, and while the XovrE valve 26 is still open, spark plug 32, which includes a spark plug tip 39 that protrudes into cylinder 14, is fired to initiate combustion in the region around the spark plug tip 39. Combustion can be initiated while the expansion piston is between 1 and 30 degrees CA past its top dead center (TDC) position. More preferably, combustion can be initiated while the expansion piston is between 5 and 25 degrees CA past its top dead center (TDC) position. Most preferably, combustion can be initiated while the expansion piston is between 10 and 20 degrees CA past its top dead center (TDC) position. Additionally, combustion may be initiated through other ignition devices and/or methods, such as with glow plugs, microwave ignition devices or through compression ignition methods.

During the exhaust stroke, exhaust gases are pumped out of the expansion cylinder 14 through exhaust port 35 disposed in cylinder head 33. An inwardly opening poppet exhaust valve 34, disposed in the inlet 31 of the exhaust port 35, controls fluid communication between the expansion cylinder 14 and the exhaust port 35. The exhaust valve 34 and the exhaust port 35 are separate from the crossover passage 22. That is, exhaust valve 34 and the exhaust port 35 do not make contact with, or are not disposed in, the crossover passage 22.

With the split-cycle engine concept, the geometric engine parameters (i.e., bore, stroke, connecting rod length, volumetric compression ratio, etc.) of the compression 12 and expansion 14 cylinders are generally independent from one another. For example, the crank throws 36, 38 for the compression cylinder 12 and expansion cylinder 14, respectively, may have different radii and may be phased apart from one another such that top dead center (TDC) of the expansion piston 30 occurs prior to TDC of the compression piston 20. This independence enables the split-cycle engine 10 to potentially achieve higher efficiency levels and greater torques than typical four-stroke engines.

The geometric independence of engine parameters in the split-cycle engine 10 is also one of the main reasons why pressure can be maintained in the crossover passage 22 as discussed earlier. Specifically, the expansion piston 30 reaches its top dead center position prior to the compression piston reaching its top dead center position by a discreet phase angle (typically between 10 and 30 crank angle degrees). This phase angle, together with proper timing of the XovrC valve 24 and the XovrE valve 26, enables the split-cycle engine 10 to maintain pressure in the crossover passage 22 at a high minimum pressure (typically 20 bar absolute or higher during full load operation) during all four strokes of its pressure/volume cycle. That is, the split-cycle engine 10 is operable to time the XovrC valve 24 and the XovrE valve 26 such that the XovrC and XovrE valves are both open for a substantial period of time (or period of crankshaft rotation) during which the expansion piston 30 descends from its TDC position towards its BDC position and the compression piston 20 simultaneously ascends from its BDC position towards its TDC position. During the period of time (or crankshaft rotation) that the crossover valves 24, 26 are both open, a substantially equal mass of air is transferred (1) from the compression cylinder 12 into the crossover passage 22 and (2) from the crossover passage 22 to the expansion cylinder 14. Accordingly, during this period, the pressure in the crossover passage is prevented from dropping below a predetermined minimum pressure (typically 20, 30, or 40 bar absolute during full load operation). Moreover, during a substantial portion of the engine cycle (typically 80% of the entire engine cycle or greater), the XovrC valve 24 and XovrE valve 26 are both closed to maintain the mass of trapped gas in the crossover passage 22 at a substantially constant level. As a result, the pressure in the crossover passage 22 is maintained at a predetermined minimum pressure during all four strokes of the engine's pressure/volume cycle.

For purposes herein, the method of having the XovrC 24 and XovrE 26 valves open while the expansion piston 30 is descending from TDC and the compression piston 20 is ascending toward TDC in order to simultaneously transfer a substantially equal mass of gas into and out of the crossover passage 22 is referred to herein as the Push-Pull method of gas transfer. It is the Push-Pull method that enables the pressure in the crossover passage 22 of the split-cycle engine 10 to be maintained at typically 20 bar or higher during all four strokes of the engine's cycle when the engine is operating at full load.

As discussed earlier, the exhaust valve 34 is disposed in the exhaust port 35 of the cylinder head 33 separate from the crossover passage 22. The structural arrangement of the exhaust valve 34 not being disposed in the crossover passage 22, and therefore the exhaust port 35 not sharing any common portion with the crossover passage 22, is preferred in order to maintain the trapped mass of gas in the crossover passage 22 during the exhaust stroke. Accordingly, large cyclic drops in pressure are prevented which may force the pressure in the crossover passage below the predetermined minimum pressure.

XovrE valve 26 opens shortly before the expansion piston 30 reaches its top dead center position. At this time, the pressure ratio of the pressure in crossover passage 22 to the pressure in expansion cylinder 14 is high, due to the fact that the minimum pressure in the crossover passage is typically 20 bar absolute or higher and the pressure in the expansion cylinder during the exhaust stroke is typically about one to two bar absolute. In other words, when XovrE valve 26 opens, the pressure in crossover passage 22 is substantially higher than the pressure in expansion cylinder 14 (typically in the order of 20 to 1 or greater). This high pressure ratio causes initial flow of the air and/or fuel charge to flow into expansion cylinder 14 at high speeds. These high flow speeds can reach the speed of sound, which is referred to as sonic flow. This sonic flow is particularly advantageous to split-cycle engine 10 because it causes a rapid combustion event, which enables the split-cycle engine 10 to maintain high combustion pressures even though ignition is initiated while the expansion piston 30 is descending from its top dead center position.

The split-cycle air-hybrid engine 10 also includes an air reservoir (tank) 40, which is operatively connected to the crossover passage 22 by an air reservoir (tank) valve 42. Embodiments with two or more crossover passages 22 may include a tank valve 42 for each crossover passage 22, which connect to a common air reservoir 40, or alternatively each crossover passage 22 may operatively connect to separate air reservoirs 40.

The tank valve 42 is typically disposed in an air reservoir (tank) port 44, which extends from crossover passage 22 to the air tank 40. The air tank port 44 is divided into a first air reservoir (tank) port section 46 and a second air reservoir (tank) port section 48. The first air tank port section 46 connects the air tank valve 42 to the crossover passage 22, and the second air tank port section 48 connects the air tank valve 42 to the air tank 40. The volume of the first air tank port section 46 includes the volume of all additional ports and recesses which connect the tank valve 42 to the crossover passage 22 when the tank valve 42 is closed.

The tank valve 42 may be any suitable valve device or system. For example, the tank valve 42 may be an active valve which is activated by various valve actuation devices (e.g., pneumatic, hydraulic, cam, electric or the like). Additionally, the tank valve 42 may comprise a tank valve system with two or more valves actuated with two or more actuation devices.

Air tank 40 is utilized to store energy in the form of compressed air and to later use that compressed air to power the crankshaft 16, as described in the aforementioned U.S. Pat. No. 7,353,786 to Scuderi et al. This mechanical means for storing potential energy provides numerous potential advantages over the current state of the art. For instance, the split-cycle engine 10 can potentially provide many advantages in fuel efficiency gains and NOx emissions reduction at relatively low manufacturing and waste disposal costs in relation to other technologies on the market, such as diesel engines and electric-hybrid systems.

By selectively controlling the opening and/or closing of the air tank valve 42 and thereby controlling communication of the air tank 40 with the crossover passage 22, the split-cycle air-hybrid engine 10 is operable in an Engine Firing (EF) mode, an Air Expander (AE) mode, an Air Compressor (AC) mode, an Air Expander and Firing (AEF) mode, and a Firing and Charging (FC) mode. The EF mode is a non-hybrid mode in which the engine operates as described above without the use of the air tank 40. The AC and FC modes are energy storage modes. The AC mode is an air-hybrid operating mode in which compressed air is stored in the air tank 40 without combustion occurring in the expansion cylinder 14 (i.e., no fuel expenditure), such as by utilizing the kinetic energy of a vehicle including the engine 10 during braking.

The FC mode is an air-hybrid operating mode in which the compression piston draws into the compression cylinder more air than is needed to power the expansion stroke of the expansion cylinder during combustion (i.e., the compressor draws in more air than is required to power the expander). The excess compressed air, not needed for combustion, is stored in the air tank 40, typically at less than full engine load operating conditions (e.g., engine idle, vehicle cruising at constant speed). The storage of compressed air in the FC mode has an energy cost (penalty) in that additional negative work is required to be performed by the compressor. Therefore, it is desirable to have a net gain when the compressed air is used at a later time (i.e., to utilize the compressed air in the expander to produce more positive work than negative work required to store the excess air during the FC mode).

The AE and AEF modes are stored energy usage modes. The AE mode is an air-hybrid operating mode in which compressed air stored in the air tank 40 is used to drive the expansion piston 30 without combustion occurring in the expansion cylinder 14 (i.e., no fuel expenditure). The AEF mode is an air-hybrid operating mode in which compressed air stored in the air tank 40 is utilized in the expansion cylinder 14 for combustion.

In the FC mode, the compression piston 20 operates in its compression mode, in that the compression piston draws in and compresses inlet air for use in the expansion cylinder 14. The expansion piston 30 operates in its power mode, in that compressed air is admitted to the expansion cylinder 14 with fuel, at the beginning of an expansion stroke, which is ignited, burned and expanded on the same expansion stroke of the expansion piston, transmitting power to the crankshaft 16, and the combustion products are discharged on the exhaust stroke. The FC mode is made possible because compression and expansion are split between the compression cylinder 12 and the expansion cylinder 14. The expansion cylinder 14 can be run at a load higher than the vehicle load. The excess load is then absorbed by the compression cylinder 12 which compresses more air than the expansion cylinder 14 requires to power the vehicle. The excess (or extra) charge air is diverted to charging the air tank 40.

Significantly, while the engine 10 is operating in the FC mode, the air tank valve 42 is kept closed until the XovrE valve 26 is substantially closed during each single rotation of the crankshaft 16. Accordingly, the expansion cylinder 14 is charged with compressed air before the air tank 40 is charged with compressed air. Thus, during a single rotation of the crankshaft 16, the expansion cylinder 14 and air tank 40 are charged serially (i.e., one after the other, rather than at the same time, which would be a parallel charging sequence). The compressed air charge provided by the compression cylinder 12 during a single rotation of the crankshaft 16 is thereby split between the expansion cylinder 14 and the air tank 40.

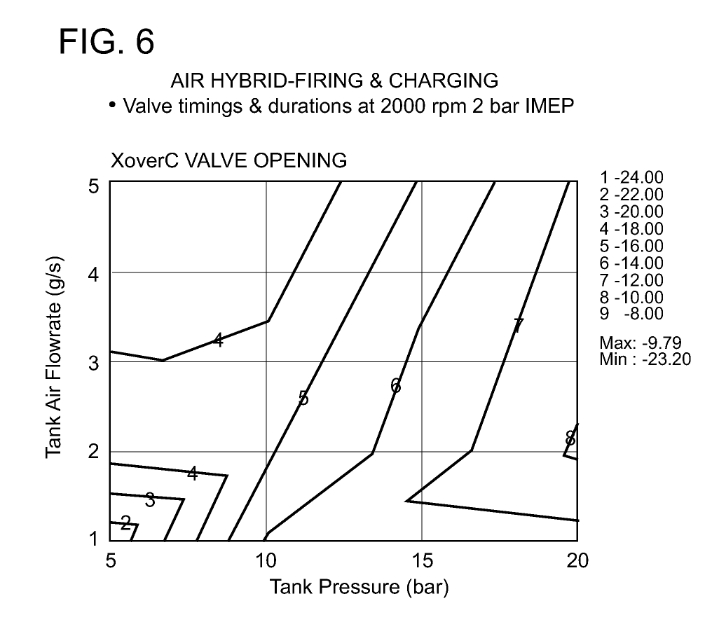

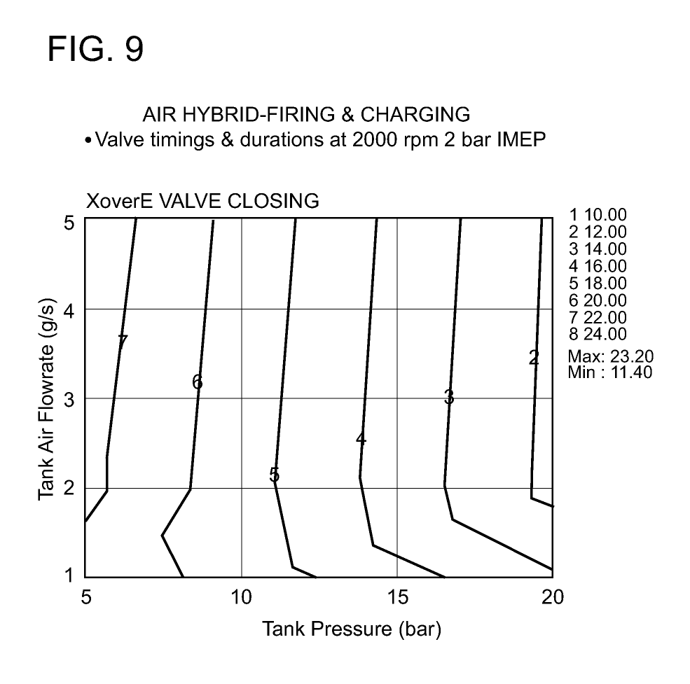

Preferably, the air tank valve 42 at least remains closed from within plus or minus 5 degrees CA of when the XovrC valve 24 opens (i.e., from when the XovrC valve is substantially open) to within plus or minus 5 degrees CA of when the XovrE valve 26 closes (i.e., to when the XovrE valve is substantially closed). Thus, the air tank valve 42 is substantially closed from a time (or a position in CA degrees) at which the compressed air charge begins to enter the crossover passage 22 through the XovrC valve 24 to a time at which the compressed air charge ceases to enter the expansion cylinder 14 through XovrE valve 26, thereby preventing the air tank 40 from being charged before the expansion cylinder. In an exemplary embodiment, the XovrC valve 24 may be opened at a crankshaft position (valve timing) between approximately −23 and −10 CA degrees ATDCe, and the XovrE valve 26 may be closed at a valve timing between approximately 11 and 23 CA degrees ATDCe, as shown in FIGS. 6 and 9, respectively.

At all operating conditions of the engine 10, the air tank valve 42 is opened only after the XovrE valve 26 has closed. For example, the air tank valve 42 may be opened at a position that is approximately 5 CA degrees or greater after the XovrE valve has closed. Preferably, the air tank valve 42 may be opened at a position that is in the range of 5-20 CA degrees after the XovrE valve 26 has closed. More preferably, the air tank valve 42 may be opened at a timing that is less than 10 degrees CA after the XovrE valve has closed. The air tank valve 42 then may be held open for a valve duration of 25 CA degrees or greater. Preferably, the air tank valve 42 may be held open for a valve duration of 50 CA degrees or greater. More preferably, the air tank valve 42 may be held open within a range of 25 to 150 CA degrees, during which time the air tank 40 is charged with compressed air.

During one complete crankshaft revolution in the FC mode beginning with the intake stroke of the compression piston 20 and ending with the exhaust stroke of the expansion piston 30, the XovrC valve 24, the XovrE valve 26, and the air tank valve 42 typically have the following sequence of openings and closings. First, the XovrC valve 24 opens and then the XovrE valve 26 opens. The crossover passage 22 is thereby pressurized with compressed air from the compression cylinder 12, and the compressed air is transferred to the expansion cylinder 14.

Typically, the XovrC valve 24 closes next, followed by the XovrE valve 26 closing. However, under some engine operating conditions, the XovrE valve 26 may close before the XovrC valve 24 closes. In either case, an amount of excess compressed air is thereby trapped in the crossover passage 22 between the closed XovrC and XovrE valves 24, 26. The crossover passage 22 is over-pressurized such that the pressure in the crossover passage is greater than the pressure in the air tank 40. Next, the air tank valve 42 opens and then later closes, allowing the excess compressed air in the crossover passage 22 to flow into the air tank 40 due to the pressure differential between the crossover passage and the air tank.

However, at certain engine operating conditions (e.g., engine speed, engine load, air tank pressure, etc.), the air tank valve 42 may open after the XovrE valve 26 has closed, but slightly before the XovrC valve 24 has closed. In this case, the sequential order of valve openings and closings is: XovrC valve 24 opens, XovrE valve 26 opens, XovrE valve 26 closes, air tank valve 42 opens, XovrC valve 24 closes, and air tank valve 42 closes. Under this valve timing sequence, the XovrC valve 24 and air tank valve 42 are open simultaneously for a short period of time, providing fluid communication (i.e., an open fluid flow path) between compression cylinder 12 and air tank 40.

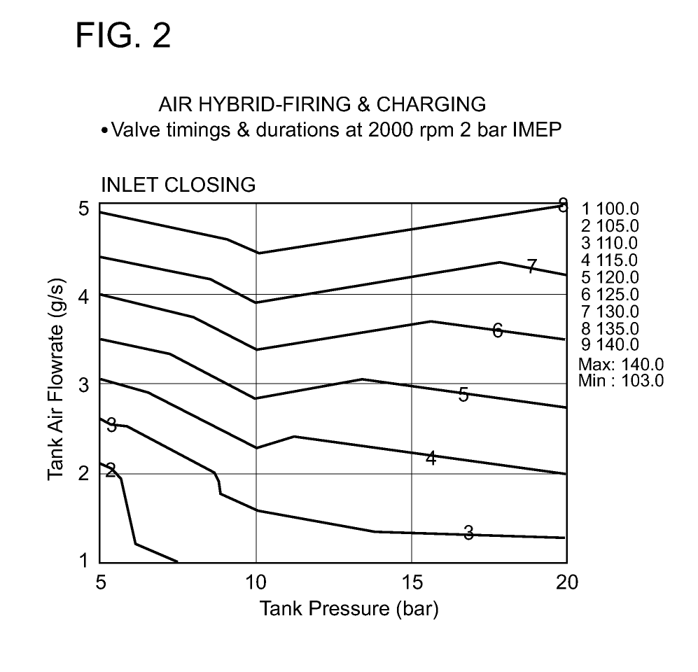

Additionally, in the FC mode, the engine load may be controlled by varying the timing of the XovrE valve closing to meter the needed amount of air into the expansion cylinder required for combustion. As stated above, in an exemplary embodiment, the XovrE valve 26 may be closed at a valve timing between approximately 11 and 23 CA degrees ATDCe, as shown in FIG. 9. Thus, the XovrE valve 26 only lets into the expansion cylinder 14 the amount of compressed charge air needed for the load required (effectively by closing when the desired charge amount has entered the expansion cylinder). The excess charge air remaining in the crossover passage 22 is then stored in the air tank 40 as described above. The amount of compressed air that is delivered to the air tank 40 during a single rotation of the crankshaft 16 (and thus the air flowrate into the air tank) may be controlled by varying the timing of the intake valve 18 closing, which effectively varies the total amount of charge air drawn into the compression cylinder 12. In an exemplary embodiment, the intake valve 18 is closed at a valve timing between approximately 103 and 140 CA degrees ATDCe as shown in FIG. 2.

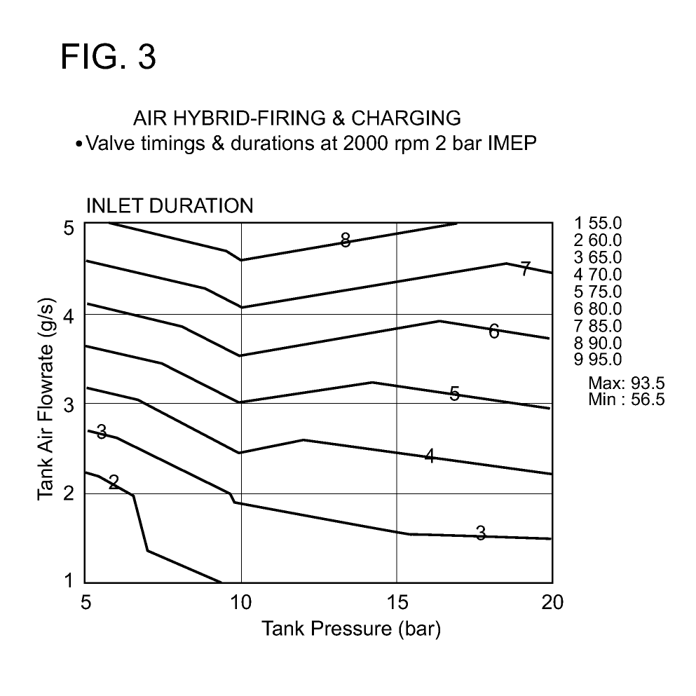

FIGS. 2 through 11 graphically illustrate an exemplary embodiment of the FC mode of the split-cycle air-hybrid engine 10 described above over a range of air tank pressures and air tank charging flowrates at an engine speed of 2000 rpm and an engine load of 2 bar IMEP. In FIG. 2, the intake valve 18 is closed at a timing in the range of 103.0 to 140.0 CA degrees ATDCe. For example, at a tank pressure of 10 bar and an air tank flowrate of 3 g/s, the intake valve 18 is closed at approximately 122 CA degrees ATDCe. In FIG. 3, the intake valve 18 has a valve duration of between 56.5 and 93.5 CA degrees. For example, at a tank pressure of 10 bar and an air tank flowrate of 3 g/s, the intake valve duration is approximately 75 CA degrees.

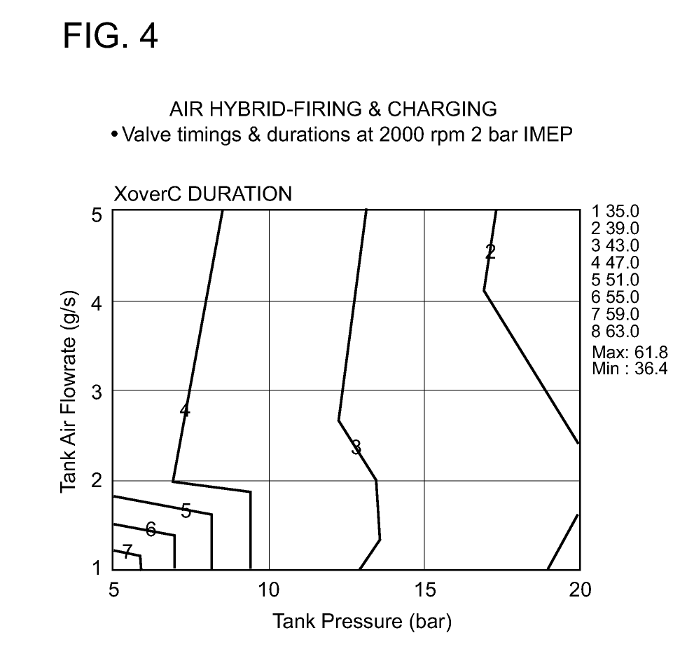

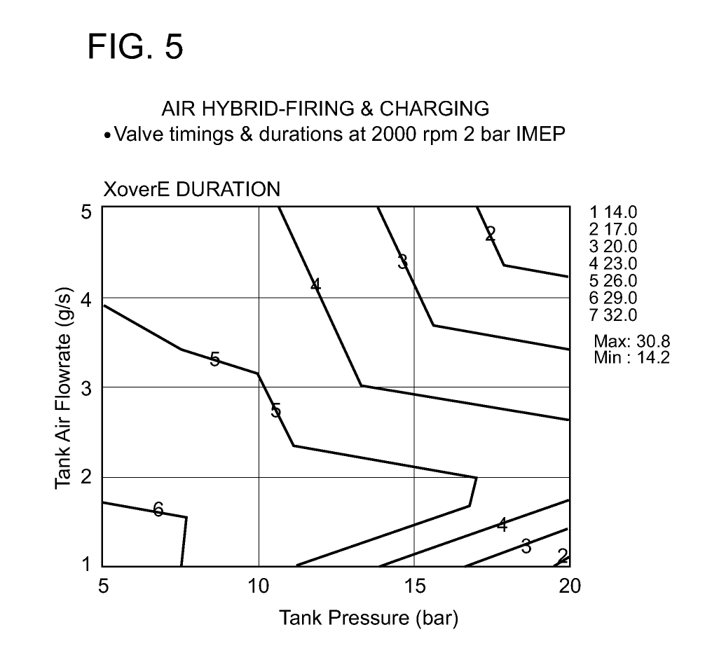

In FIG. 4, the XovrC valve 24 has a valve duration of between 36.4 and 61.8 CA degrees. For example, at a tank pressure of 10 bar and an air tank flowrate of 3 g/s, the XovrC valve duration is approximately 45 CA degrees. In FIG. 5, the XovrE valve 26 has a valve duration of between 14.2 and 30.8 CA degrees. For example, at a tank pressure of 10 bar and an air tank flowrate of 3 g/s, the XovrE valve duration is approximately 26 CA degrees.

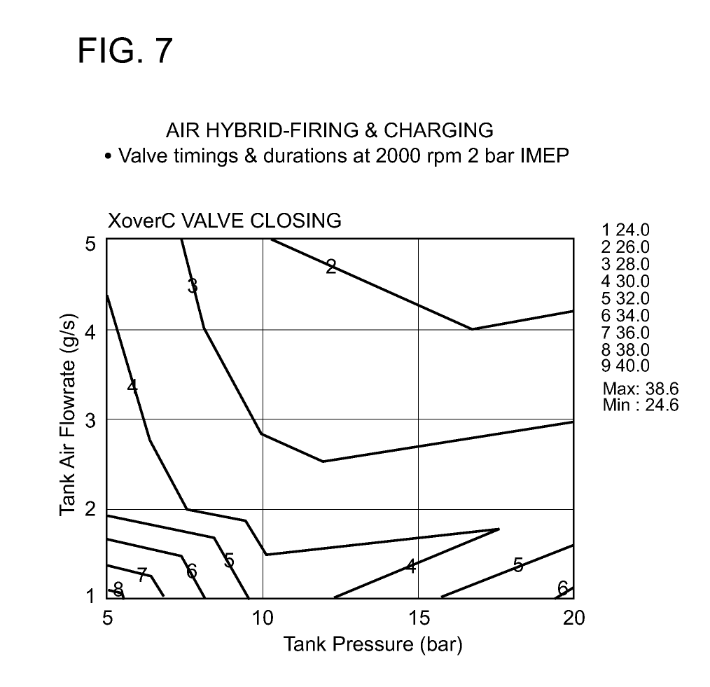

FIGS. 6 and 7 depict the XovrC valve 24 opening and closing timings, respectively. The XovrC valve 24 opens at a timing in the range of −23.20 to −9.79 CA degrees ATDCe and closes at a timing in the range of 24.6 to 38.6 CA degrees ATDCe. For example, at a tank pressure of 10 bar and an air tank flowrate of 3 g/s, the XovrC valve 24 opens at approximately −17.5 CA degrees ATDCe and closes at approximately 28 CA degrees ATDCe.

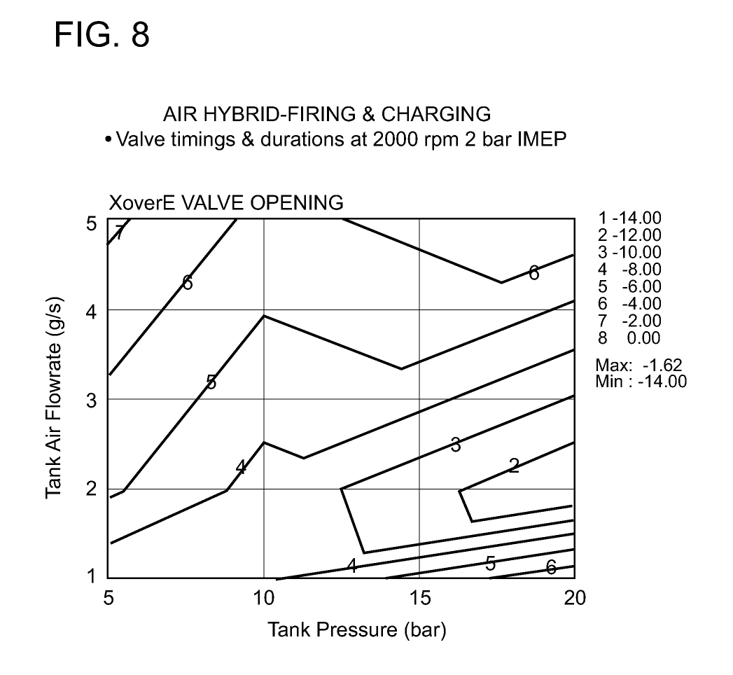

FIGS. 8 and 9 depict the XovrE valve 26 opening and closing timings, respectively. The XovrE valve 26 opens at a timing in the range of −1.62 to 14.00 CA degrees ATDCe and closes at a timing in the range of 11.40 to 23.20 CA degrees ATDCe. For example, at a tank pressure of 10 bar and an air tank flowrate of 3 g/s, the XovrE valve 26 opens at approximately −7.3 CA degrees ATDCe and closes at approximately 19 CA degrees ATDCe.

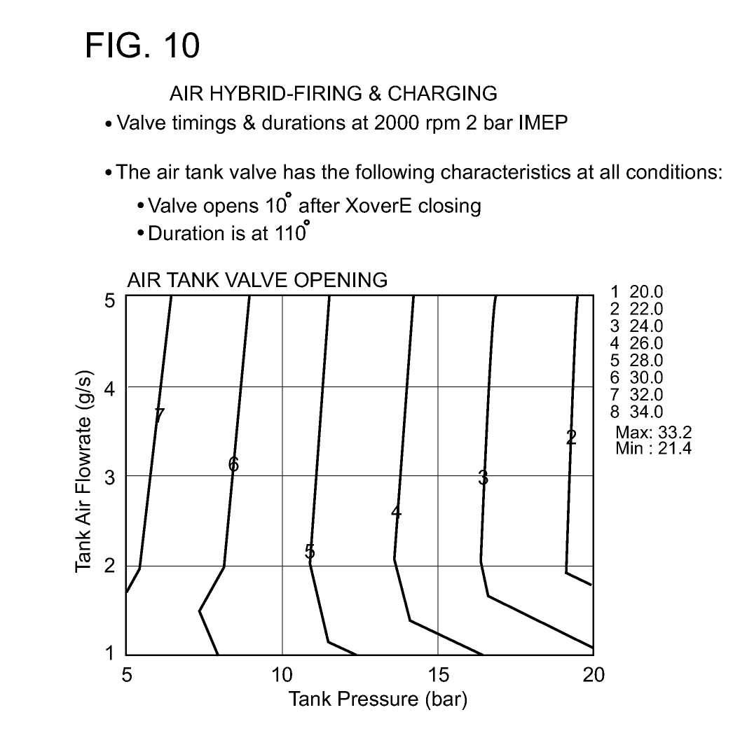

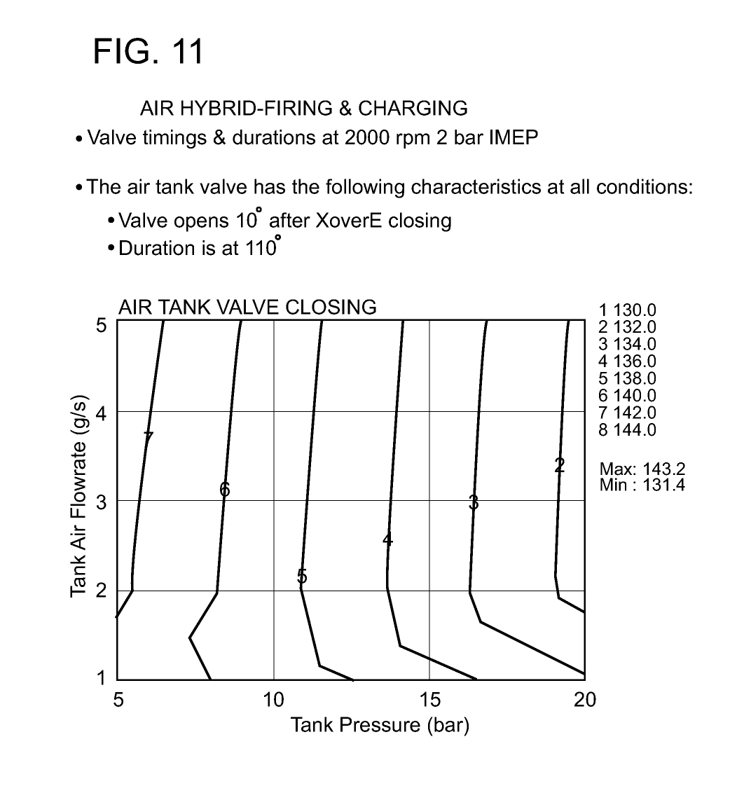

FIGS. 10 and 11 depict the air tank valve 42 opening and closing timings, respectively. The air tank valve 42 opens at a timing in the range of 21.4 to 33.2 CA degrees ATDCe and closes at a timing in the range of 131.4 to 143.2 CA degrees ATDCe. For example, at a tank pressure of 10 bar and an air tank flowrate of 3 g/s, the air tank valve 42 opens at approximately 29 CA degrees ATDCe and closes at approximately 139 CA degrees ATDCe.

As can be seen from FIGS. 9-11, over the range of air tank pressures and air tank charging flowrates, in this exemplary embodiment the air tank valve 42 opens 10 CA degrees after the XovrE valve 26 closes, and the air tank valve closes 110 CA degrees after it opens (i.e., the air tank valve duration is substantially fixed at 110 CA degrees).

The above exemplary embodiment has illustrated a valve timing sequence for the FC mode at a single engine speed and load (i.e., 2000 rpm at 2 bar IMEP). However, one skilled in the art would recognize that the FC mode may operate over the entire speed and load range of the engine 10. That is, the FC mode may operate from no-load to full-load and from idle speed to rated (full) speed of engine 10.

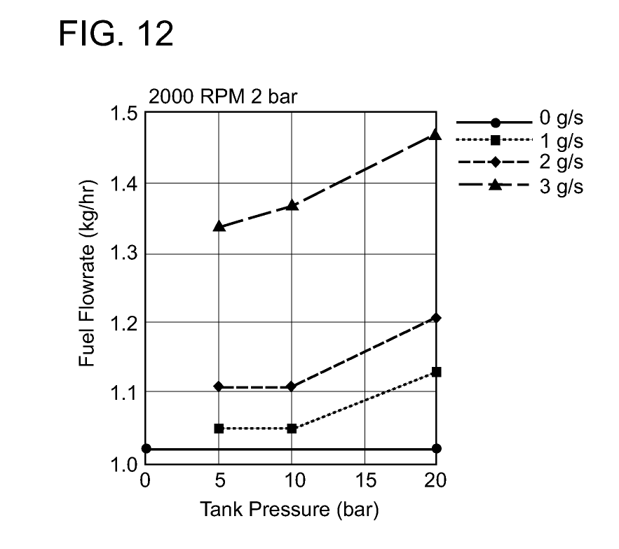

FIG. 12 graphically illustrates the fuel (i.e., energy) penalty for compressing excess air in the compression cylinder 12 (for subsequently charging the air tank 40) in the FC mode at an exemplary engine speed of 2000 rpm and engine load of 2 bar IMEP. The horizontal line at the bottom of the graph (air tank charging rate of 0 g/s) represents the fuel flowrate (in kg/hr) when the air tank 40 is not being charged (essentially the EF (or NF) mode of the engine 10). This is the zero fuel penalty baseline from which the fuel penalty in the FC mode is calculated. The three lines above the horizontal baseline represent fuel expenditures in the FC mode at air tank charging rates of 1 g/s, 2 g/s, and 3 g/s. The fuel expenditures in the FC mode are, of course, greater than the fuel expenditure in the EF mode. The fuel penalty in the FC mode is calculated by subtracting the baseline fuel expenditure from the fuel expenditure at a specific air tank pressure and air tank charging rate. For example, at an air tank pressure of 5 bar and an air tank charging rate of 2 g/s, the fuel penalty (extra energy spent to charge the air tank) is approximately 0.09 kg/hr (1.11 kg/hr at 5 bar and 2 g/s minus the baseline expenditure of 1.02 kg/hr). As another example, at an air tank pressure of 10 bar and an air tank charging rate of 3 g/s, the fuel penalty is approximately 0.35 kg/hr (1.37 kg/hr minus 1.02 kg/hr).

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A split-cycle air-hybrid engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an intake valve selectively controlling air flow into the compression cylinder;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and a crossover expansion (XovrE) valve defining a pressure chamber therebetween;
an air reservoir operatively connected to the crossover passage and selectively operable to store compressed air from the compression cylinder; and
an air reservoir valve selectively controlling air flow into and out of the air reservoir;
the engine being operable in a Firing and Charging (FC) mode, wherein, in the FC mode, the air reservoir valve is kept closed until the XovrE valve is substantially closed during a single rotation of the crankshaft such that the expansion cylinder is charged with compressed air before the air reservoir is charged with compressed air.

2. The split-cycle air-hybrid engine of claim 1, wherein, in the FC mode, the air reservoir valve remains closed in a range of from within plus or minus 5 degrees CA of when the XovrC valve opens to within plus or minus 5 degrees CA of when the XovrE valve closes.

3. The split-cycle air-hybrid engine of claim 1, wherein, in the FC mode, the air reservoir valve opens at a position 5 degrees CA or greater after the XovrE valve closes.

4. The split-cycle air-hybrid engine of claim 1, wherein, in the FC mode, the air reservoir valve opens at a position in a range of 5-20 degrees CA after the XovrE valve closes.

5. The split-cycle air-hybrid engine of claim 1, wherein, in the FC mode, the air reservoir valve opens at a position less than 10 degrees CA after the XovrE valve closes.

6. The split-cycle air-hybrid engine of claim 1, wherein, in the FC mode, the air reservoir valve is kept open for a duration of 25 degrees CA or greater.

7. The split-cycle air-hybrid engine of claim 1, wherein, in the FC mode, the air reservoir valve is kept open for a duration of 50 degrees CA or greater.

8. The split-cycle air-hybrid engine of claim 1, wherein, in the FC mode, the air reservoir valve is kept open for a duration within a range of 25 degrees CA to 150 degrees CA.

9. The split-cycle air-hybrid engine of claim 1, wherein, in the FC mode, engine load is controlled by controlling the timing of XovrE valve closing.

10. The split-cycle air-hybrid engine of claim 1, wherein, in the FC mode, an amount of excess compressed air delivered to the air reservoir is controlled by controlling the timing of intake valve closing.

11. The split-cycle air-hybrid engine of claim 1, wherein, in the FC mode, the compression piston draws in and compresses inlet air for use in the expansion cylinder, and compressed air is admitted to the expansion cylinder with fuel, at the beginning of an expansion stroke, which is ignited, burned and expanded on the same expansion stroke of the expansion piston, transmitting power to the crankshaft, and the combustion products are discharged on the exhaust stroke.

12. A method of operating a split-cycle air-hybrid engine including:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an intake valve selectively controlling air flow into the compression cylinder;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and a crossover expansion (XovrE) valve defining a pressure chamber therebetween;
an air reservoir operatively connected to the crossover passage and selectively operable to store compressed air from the compression cylinder; and
an air reservoir valve selectively controlling air flow into and out of the air reservoir;
the engine being operable in a Firing and Charging (FC) mode;
the method including the steps of:
drawing in and compressing inlet air with the compression piston;
admitting compressed air from the compression cylinder into the expansion cylinder with fuel, at the beginning of an expansion stroke, the fuel being ignited, burned and expanded on the same expansion stroke of the expansion piston, transmitting power to the crankshaft, and the combustion products being discharged on the exhaust stroke; and
keeping the air reservoir valve closed until the XovrE valve is substantially closed during a single rotation of the crankshaft such that the expansion cylinder is charged with compressed air before the air reservoir is charged with compressed air.

13. The method of claim 12, including the step of keeping the air reservoir valve closed in a range of from within plus or minus 5 degrees CA of when the XovrC valve opens to within plus or minus 5 degrees CA of when the XovrE valve closes.

14. The method of claim 12, including the step of opening the air reservoir valve at a position 5 degrees CA or greater after the XovrE valve closes.

15. The method of claim 12, including the step of opening the air reservoir valve at a position in a range of 5-20 degrees CA after the XovrE valve closes.

16. The method of claim 12, including the step of opening the air reservoir valve at a position less than 10 degrees CA after the XovrE valve closes.

17. The method of claim 12, including the step of keeping the air reservoir valve open for a duration of 25 degrees CA or greater.

18. The method of claim 12, further including the step of controlling engine load by varying the timing of XovrE valve closing.

19. The method of claim 12, further including the step of controlling an amount of excess compressed air delivered to the air reservoir by varying the timing of intake valve closing.
